(19) United States
(12) Patent Application Publication
(10) Pub. No.: US 2006/0129330 A1
(43) Pub. Date: Jun. 15, 2006

(54) System and method for graphically representing genomic sequence data

(76) Inventor: Isaac Bentwich, Kvutzat Shiler (IL)

Correspondence Address: HOWREY LLP, C/O IP DOCKETING DEPARTMENT, 2941 FAIRVIEW PARK DR, SUITE 200, FALLS CHURCH, VA, 22042-2924, US

(21) Appl. No.: 09/976,911

(22) Filed: Oct. 12, 2001

(51) Int. Cl. G06F 19/00

(52) U.S. Cl. 702/20

(57) ABSTRACT

A system and method for displaying genomic sequence data by expressing an alphanumeric string using a representation which distinguishes a first plurality of nucleotides, sharing in common a first genomic attribute, from a second plurality of nucleotides, sharing in common a second genomic attribute, which is different from the first genomic attribute.

### FIELD OF THE INVENTION

The present invention relates to representation of genomic sequence data in general.

### BACKGROUND OF THE INVENTION

Alongside the ongoing progress in sequencing of genomes of multiple organisms, a major focus of increasing importance is the analysis of this genomic sequence data. Genomic sequence data is typically represented as alphanumeric strings.

The following U.S. patents are believed to represent the state of the art: U.S. Pat. Nos. 5,966,712; 5,966,711; 5,853,989; and 5,811,235.

### SUMMARY OF THE INVENTION

The present invention seeks to provide an improved method for presentation of genomic sequence data In various preferred embodiments, the present invention seeks to increase the ease with which genomic motifs and their inverse-reversed sequences may be visually distinguished from each other.

Preferably, the present invention enhances the ease with which a viewer can visually distinguish purine nucleotides from pyrimidine nucleotides and can visually distinguish one set of complementary nucleotides, i.e. adenine-thymine, from another set of complementary nucleotides, i.e. guanine-cytosine. These and other enhanced visual distinctions are preferably provided by employing a novel type of genomic computer font. Different colors may also be applied to different nucleotides.

There is thus provided in accordance with a preferred embodiment of the present invention a method for displaying genomic sequence data, the method including: receiving an alphanumeric string representing genomic sequence data, the alphanumeric string including a plurality of characters, each of the characters representing a nucleotide in the genomic sequence; and expressing the alphanumeric string using a representation which distinguishes a first plurality of nucleotides, sharing in common a first genomic attribute, from a second plurality of nucleotides, sharing in common a second genomic attribute, the second genomic attribute being different from the first genomic attribute.

There is further provided in accordance with another preferred embodiment of the present invention a method for graphically displaying genomic sequence information, the method including: receiving a first alphanumeric string representing a first genomic sequence, and a second alphanumeric string representing a second genomic sequence, the second genomic sequence being a reversed-inversed genomic sequence of the first genomic sequence; and graphically displaying the first alphanumeric string and the second alphanumeric string, such that a graphical display of the second alphanumeric string is a horizontal and vertical mirror image of a graphical display of the first alphanumeric sting.

There is still further provided in accordance with another preferred embodiment of the present invention a genomic display system comprising: a receiving apparatus operative to receive an alphanumeric string representing genomic sequence data, said alphanumeric string comprising a plurality of characters, each of said characters representing a nucleotide in said genomic sequence; and an expressing apparatus operative to express said alphanumeric string using a representation which distinguishes a first plurality of nucleotides, sharing in common a first genomic attribute, from a second plurality of nucleotides, sharing in common a second genomic attribute, said second genomic attribute being different from said first genomic attribute.

There is additionally provided in accordance with another preferred embodiment of the present invention a system for graphically displaying genomic sequence information, the system comprising: a genomic sequence expressor, receiving a first alphanumeric string representing a first genomic sequence and a second alphanumeric string representing a second genomic sequence, said second genomic sequence being a reversed-inversed genomic sequence of said first genomic sequence; and expressing said first alphanumeric string and said second alphanumeric string, such that a graphical display of said second alphanumeric string is a horizontal and vertical mirror image of a graphical display of said first alphanumeric string; and a display operative to receive an output from said genomic sequence expressor and to provide a visually sensible display of an expression of said graphical display of said first alphanumeric string and said graphical display of said second alphanumeric string.

There is also provided in accordance with another preferred embodiment of the present invention a computer-readable medium comprising a computer program, the computer program being operative, when in operative association with a computer, to perform the following steps: receiving an alphanumeric string representing genomic sequence data, said alphanumeric string comprising a plurality of characters, each of said characters representing a nucleotide in said genomic sequence; and expressing said alphanumeric string using a representation which distinguishes a first plurality of nucleotides, sharing in common a first genomic attribute, from a second plurality of nucleotides, sharing in common a second genomic attribute, said second genomic attribute being different from said first genomic attribute. In accordance with a preferred embodiment of the present invention, the first plurality of nucleotides are represented by at least one first representing attribute, and the second plurality of nucleotides are represented by at least one second representing attribute, the second representing attribute being different from the first representing attribute.

There is further provided in accordance with another preferred embodiment of the present invention a computer-readable medium comprising a computer program, the computer program being operative, when in operative association with a computer, to perform the following steps: receiving a first alphanumeric string representing a first genomic sequence and a second alphanumeric string representing a second genomic sequence, said second genomic sequence being a reversed-inversed genomic sequence of said first genomic sequence; and graphically displaying said first alphanumeric string and said second alphanumeric string, such that a graphical display of said second alphanumeric string is a horizontal and vertical mirror image of a graphical display of said first alphanumeric string.

Further in accordance with a preferred embodiment of the present invention the representation comprises a human sensible representation.

Still further in accordance with a preferred embodiment of the present invention the at least one first representing attribute and the at least one second representing attribute are graphical attributes.

Additionally in accordance with a preferred embodiment of the present invention the graphical attributes are shapes.

Moreover in accordance with a preferred embodiment of the present invention the graphical attributes are positions.

Further in accordance with a preferred embodiment of the present invention the positions are vertical positions.

Still further in accordance with a preferred embodiment of the present invention the graphical attributes are orientations.

Additionally in accordance with a preferred embodiment of the present invention the orientations are vertical orientations.

Moreover in accordance with a preferred embodiment of the present invention the graphical attributes are colors.

Further in accordance with a preferred embodiment of the present invention using the representation also includes representing each of four nucleotides: adenine, thymine, cytosine, and guanine, by a different color.

Still further in accordance with a preferred embodiment of the present invention the human sensible representation includes one of the following: a shape with a letter and a shape without a letter.

Additionally in accordance with a preferred embodiment of the present invention the hunian sensible representation is produced using a computer font.

Moreover in accordance with a preferred embodiment of the present invention the computer font is a TRUETYPE® font.

Further in accordance with a preferred embodiment of the present invention the representation comprises a machine sensible representation.

Still further in accordance with a preferred embodiment of the present invention the at least one first representing attribute and the at least one second representing attribute are machine sensible attributes.

Additionally in accordance with a preferred embodiment of the present invention the first plurality of nucleotides are purine nucleotides, and the second plurality of nucleotides are pyrimidine nucleotides.

Moreover in accordance with a preferred embodiment of the present invention the first plurality of nucleotides consists of adenine and thymine nucleotides, and the second plurality of nucleotides consists of guanine and cytosine nucleotides.

Further in accordance with a preferred embodiment of the present invention the representation also distinguishes a third plurality of nucleotides, sharing in common a third genomic attribute, from a fourth plurality of nucleotides, sharing in common a fourth genomic attribute, the fourth genomic attribute being different from the third genomic attribute.

Still further in accordance with a preferred embodiment of the present invention the third plurality of nucleotides are represented by at least one third representing attribute, and the fourth plurality of nucleotides are represented by at least one fourth representing attribute, the at least one third representing attribute being different from the at least one fourth representing attribute.

Additionally in accordance with a preferred embodiment of the present invention the first plurality of nucleotides are purine nucleotides, the second plurality of nucleotides are pyrimidine nucleotides, the third plurality of nucleotides are adenine and thymine nucleotides, and the fourth plurality of nucleotides are guanine and cytosine nucleotides.

Moreover in accordance with a preferred embodiment of the present invention the method also includes expressing the first alphanumeric string and the second alphanumeric string using a representation which distinguishes a first plurality of nucleotides, sharing in common a first genomic attribute, from a second plurality of nucleotides, sharing in common a second genomic attribute, the second genomic attribute being different from the first genomic attribute.

Further in accordance with a preferred embodiment of the present invention the genomic sequence expressor is also operative to receive an alphanumeric string which represents genomic sequence data, the alphanumeric string including a plurality of characters, each of the plurality of characters representing a nucleotide in the genomic sequence, and to express the alphanumeric string using a representation which distinguishes a first plurality of nucleotides, sharing in common a first genomic attribute, from a second plurality of nucleotides, sharing in common a second genomic attribute, the second genomic attribute being different from the first genomic attribute, and the display is also operative to receive an output from the expressor and to display the genomic sequence using the representation.

### BRIEF DESCRIPTION OF THE DRAWINGS

The present invention will be understood and appreciated more fully from the following detailed description, taken in conjunction with the drawings in which:

FIG. 1 is a simplified block diagram illustrating a computer application constructed and operative in accordance with a preferred embodiment of the present invention;

FIG. 2 is a simplified flowchart illustrating preferred operation of a genomic graphic representation engine, constructed and operative in accordance with a preferred embodiment of the present invention;

FIG. 3 is a simplified illustration of an example demonstrating conversion of alphanumeric genomic representation into graphic genomic representation;

FIG. 4 is a simplified illustration of an example demonstrating an advantage of a graphic genomic representation in comparing a genomic motif sequence with the inverse-reversed sequence this motif;

FIG. 5 is a simplified illustration of an example demonstrating an advantage of a graphic genomic representation, in visually distinguishing adenine-thymine-rich sequences, from cytosine-guanine-rich sequences; and

FIG. 6 is a simplified illustration of an example demonstrating an advantage of a graphic genomic representation, in visually distinguishing purine nucleotides from pyrimidine nucleotides.

### DETAILED DESCRIPTION OF A PREFERRED EMBODIMENT

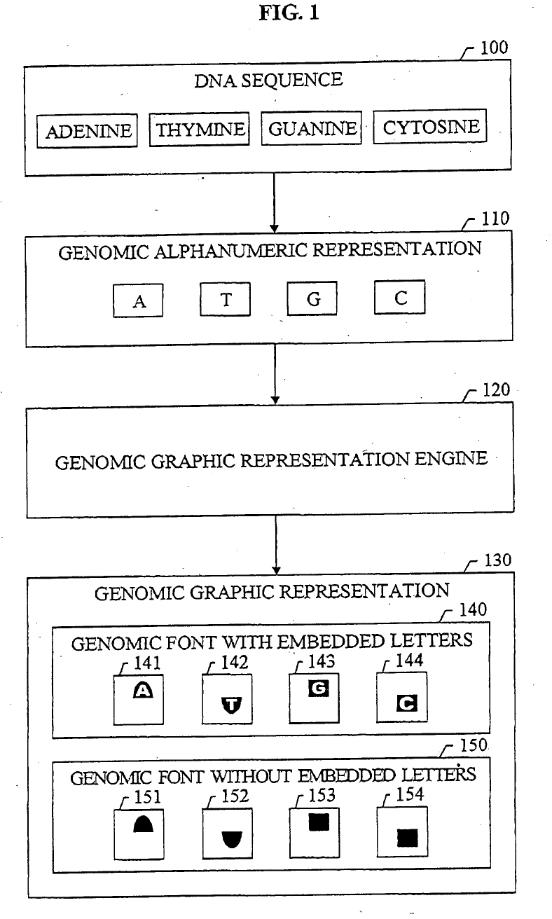

Reference is now made to FIG. 1, which is a simplified block diagram illustrating a computer application constructed and operative in accordance with a preferred embodiment of the present invention. It is appreciated that the computer application may be implemented in any appropriately programmed computer system such as, for example, a suitable personal computer including an operating system having a suitable graphical user interface.

The embodiment of FIG. 1 comprises a mechanism for conversion of a standard alphanumeric representation of genomic sequence information into a more informative and intuitive graphical representation, conducive to visual pattern analysis of genomic sequence information.

Sequenced DNA 100 is biological information relating to a sequence of nucleotides—adenine, thymine, guanine, and cytosine—of a given DNA molecule, or genome. Determining the sequence of nucleotides of a genome is achieved by various ‘wet-lab’ sequencing methodologies and techniques, as is well known in the art.

The resulting genomic sequence is typically represented in a genomic alphanumeric representation 110, which is an alphanumeric string used both for computer storage of sequenced DNA data and for its presentation. The genomic alphanumeric representation 110 comprises primarily four letters ‘A’ representing adenine, ‘T’ representing thymine, ‘G’ representing guanine and ‘C’ representing cytosine.

As is well known in the art, the nucleotide adenine, represented by ‘A’, is a ‘counterpart’ of the nucleotide thymine represented by T: wherever the DNA sequence on one DNA strand contains adenine, the opposite strand at that exact location contains thymine, and vice-versa Similarly, the nucleotide guanine represented by ‘G’ is a ‘counterpart’ of nucleotide cytosine represented by C. Wherever the DNA sequence on one DNA strand contains guanine, the opposite strand at that exact location contains cytosine, and vice-versa.

Also, as is well known in the art, adenine represented by ‘A’ and guanine represented by ‘G’ are purine nucleotides, whereas thymine represented by ‘T’ and cytosine represented by ‘C’ are pyrimidine nucleotides.

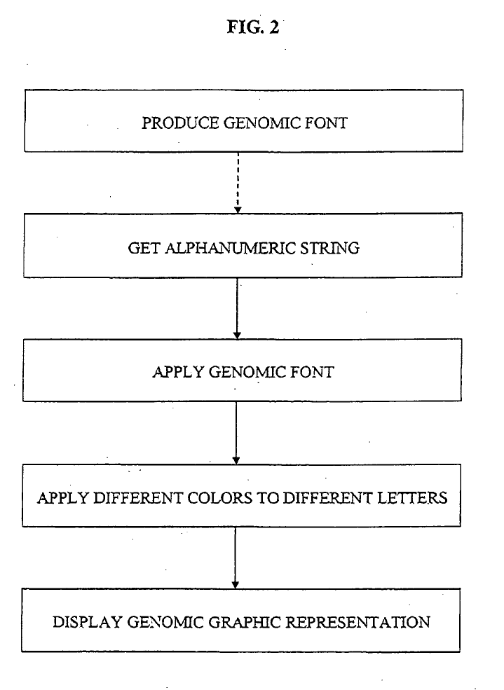

In accordance with a preferred embodiment of the present invention, a genomic graphic representation engine 120 receives the genomic alphanumeric representation 110 and converts it into a genomic graphical representation 130. A preferred embodiment of a genomic graphic representation engine 120 is further described below with reference to FIG. 2.

The genomic graphic representation 130, produced by the genomic graphic representation engine 120, preferably represents each of the four letters—‘A’, ‘T’, ‘G’ and ‘C’—in the original genomic alphanumeric representation 110, using a plurality of graphic parameters. In a preferred embodiment of the invention, the alphanumeric representation 110 is represented by a combination of a graphic shape, a vertical orientation, and a color specific to that letter, as is further described below.

As is known in the art, the genomic sequence data may also include unknown nucleotides, i.e. nucleotides in the genomic sequence which the sequencing process was unable to identify. Unknown nucleotides are typically represented by ‘N’ or ‘-’. These may be also be represented by the graphic representation 130 by a designated shape, color, and letter, as per user preference.

A preferred embodiment of the genomic graphic representation 130 may include a genomic font with embedded letters 140, in which a letter representing each nucleotide is embedded on a shape that represents it graphically. In a preferred embodiment of the present invention the following shapes are used: The letter ‘A’ is represented by an upward oriented half-oval with an embedded letter ‘A’, as illustrated by reference numeral 141. The letter ‘T’ is represented by a downward oriented half-oval with an embedded letter ‘T’, as illustrated by reference numeral 142. The letter ‘G’ is represented by an upward oriented half-square with an embedded letter ‘G’, as illustrated by reference numeral 143. The letter ‘C’ is represented by a downward oriented half-square with an embedded letter ‘C’, as illustrated by reference numeral 144.

Alternatively, the genomic graphic representation 130 may also include a genomic font without letters 150, in which only a shape is used to graphically represent each letter, without any letter embedded on the shape. In a preferred embodiment of the present invention an upward oriented half-oval 151 represents ‘A’, a downward oriented half-oval 152 represents ‘T’, an upward oriented half-square 153 represents ‘G’, and a downward oriented half-square 154 represents ‘C’.

Preferably, each of the four shapes without letters 151, 152, 153 & 154, or alternatively each of the four shapes with embedded letters 141, 142, 143 & 144, representing the four letters ‘A’, ‘T’, ‘G’ and ‘C’ respectively, may be displayed in a different color, according to the user's preference. A preferred embodiment of the current invention displays the above mentioned shapes in red, blue, brown, and green respectively.

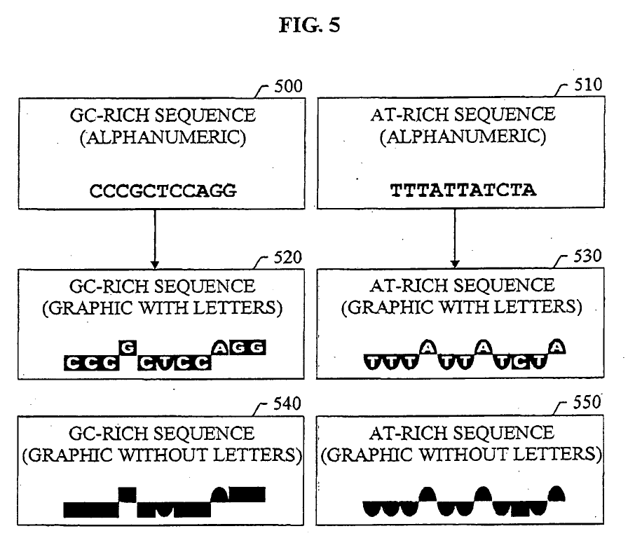

It is appreciated that the genomic graphic representation 130 described above provides enhanced visual discrimination between adenine-thymine counterparts, and guanine-cytosine counterparts. Preferably, ‘A’ and ‘T’ are represented by two vertical ‘complementary’ halves of one shape. For example, in a preferred embodiment of the current invention, ‘A’ and ‘T’ are represented by two halves of an oval 151 and 152 respectively. Similarly, ‘G’ and ‘C’ are also represented by two vertical complementary halves of a different shape. For example, as in a preferred embodiment of the current invention, ‘G’ and ‘C’ are represented by two halves of a square 153 and 154 respectively. An example of the usefulness of enhanced ease of visual discrimination between adenine-thymine counterparts and guanine-cytosine counterparts, is distinguishing ‘AT-rich’ DNA segments, i.e. segments in which there is a higher incidence of adenine and thymine nucleotides, from ‘CG-rich’ DNA segments, i.e. segments in which there is a higher incidence of cytosine and guanine nucleotides. It is appreciated that AT-rich DNA segments, in which the oval shapes are more dominant, can be discerned visually with enhanced ease from ‘CG-rich’ segments, in which square shapes are more dominant. Different shapes may be utilized other than the ones described here, e.g. a triangle may be used instead of an half-oval. Enhanced visual discernment of AT-rich from CG-rich DNA sequences is further described below with reference to FIG. 5.

It is further appreciated that the genomic graphic representation 130 described above also provides the user with enhanced ease of visually distinguishing purine nucleotides from pyrimidine nucleotides. According to a preferred embodiment of the current invention, both purine nucleotides adenine (‘A’) and guanine (‘G’) are graphically represented by shapes that have an upward orientation: an upward oriented half-oval 151 and an upward oriented half-square 153 respectively. Similarly, both pyrimidine nucleotides thymine (‘T’) and cytosine (‘C’) are graphically represented by shapes that have a downward orientation: a downward oriented half-oval 152 and a downward oriented half-square 154 respectively. An example for the usefulness of the enhanced ease of visually distinguishing purine nucleotides from pyrimidine nucleotides is the enhanced ease of visually discerning the similarity between two genomic motifs: When comparing two genomic motifs, one ending with adenine (‘A’) while the other ends with guanine (‘G’), both adenine and guanine being purine nucleotides, since both adenine and guanine are graphically represented by upward oriented shapes, the similarity between these two genomics motifs, is made more visually apparent Visually distinguishing of purine nucleotides from pyrimidine nucleotides is further described below with reference to FIG. 5.

It is yet further appreciated that the genomic graphic representation 130 described above may also provide enhanced visual discrimination between the four different nucleotides, based on their different colors.

It is appreciated that while FIG. 1 illustrates a human sensible, graphical representation of genomic sequence data in order to represent a one or more genomic attributes of each of the four nucleotides, another implementation of the present invention may use machine sensible representation in order to represent these attributes.

Reference is now made to FIG. 2 which is a simplified flowchart illustrating preferred operation of the genomic graphic representation engine 120 of FIG. 1, constructed and operative in accordance with a preferred embodiment of the present invention.

First, a genomic font is produced, preferably using conventional font-creation software, such as ‘FONT CREATOR PROGRAM’ In this font, preferred shapes are assigned to each of the four letters ‘A’, ‘T’, ‘G’ and ‘C’, such as the shapes indicated by reference numerals 151-154 of FIG. 1 respectively. Preferably two variations of the genomic font are employed: the first comprising shapes with embedded letters in shapes, as designated by reference numeral 140, and the other comprising shapes without embedded letters, as designated by reference numeral 150 both of FIG. 1. The preferred shapes for each of the four letters, ‘A’, ‘T’, ‘G’ & ‘C’, are preferably those designated by reference numerals 141, 142, 143 & 144 and by reference numerals 151, 152, 153 & 154 respectively in FIG. 1.

The process of generating a genomic font preferably is a one-time process, and hence is connected to the next step by a broken line. It is typically carried out once, before an iterative process of converting the representation of multiple genomic sequences, from a genomic alphanumeric representation 110 into a genomic graphic representation 130.

Once a genomic font has been created, the process of graphically representing genomic sequence data may be very simple: an alphanumeric string representing genomic sequence data is received and a genomic font, generated by the previous step, is applied to this alphanumeric string.

Different colors may be applied to different letters, typically by using standard ‘search-and-replace’ commands, as is known in the art. In a preferred embodiment of the present invention, the colors applied to the letters ‘A’, ‘T’, ‘G’ & ‘C’ are red, blue, brown & green respectively. Clearly, other colors may be used, according to user preferences. It should be noted, that applying different colors to different letters is an optional step: the user may or may not want to view the different letters in different colors, or may want to view a group of letters, for example purine nucleotides or pyrimidine nucleotides, or A-T or C-G, or some other grouping in a certain color.

Finally, the resulting alphanumeric string, now displayed graphically by the genomic font, may be displayed.

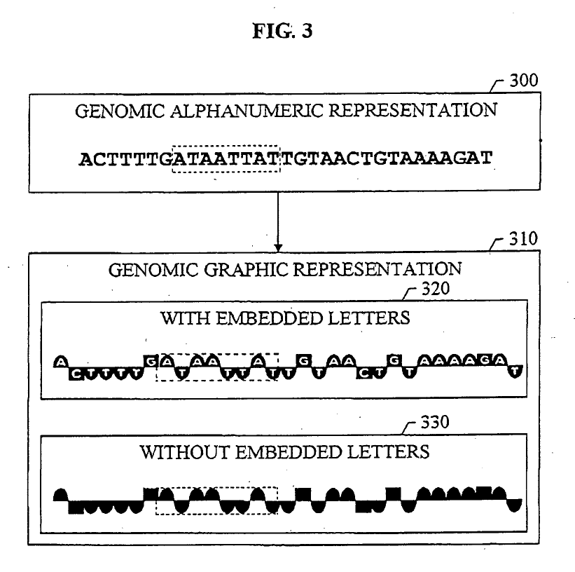

Reference is now made to FIG. 3 which is a simplified illustration depicting an example of conversion of a typical alphanumeric genomic representation, of the type indicated by reference numeral 110 of FIG. 1, into a typical graphic genomic representation, of the type indicated by reference numeral 130 of FIG. 1.

Reference numeral 300 designates an example of a short genomic sequence, conventionally represented by an alphanumeric string ‘ACTTTTGATAATTATTGTAACTGTAAAAGAT’.

The short genomic sequence 300 may be displayed using a genomic graphic representation as designated by reference numeral 310, either employing genomic font with embedded letters 140 of FIG. 1, as designated by reference numeral 320 or employing genomic font without embedded letters 150 of FIG. 1, as designated by reference numeral 330.

It is appreciated that it is easier to visually discern patterns in the genomic sequence when it is displayed as a genomic graphic representation 310, than when displayed as genomic alphanumeric representation 300. For example, when viewing the genomic alphanumeric representation 300, the segment ‘ATAATTAT’, 8^{th}-15^{th} characters in the string from its left end, surrounded by a broken-line border, may not immediately stand out as having any special significance. However, when examining the same segment in the genomic graphic representation without embedded letters 330, a visual pattern is apparent: the first four characters in this segment, ‘ATAA’, are a vertical and horizontal mirror image of the last four characters of the segment, ‘TTAT’. A genomic sequence in which the second half of the sequence is a reversed-inversed sequence relative to the first half of the sequence, such as ‘ATTATTAT’ in the given example in designated by reference numeral 300 is known in the art as a ‘hair-pin structure’

It is thus easier to visually discern a genomic pattern, indicating that the sequence ‘ATAATTAT’ is what: a genomic sequence in which ‘Hair-pin’ sequences are genomic patterns which may indeed be biologically significant.

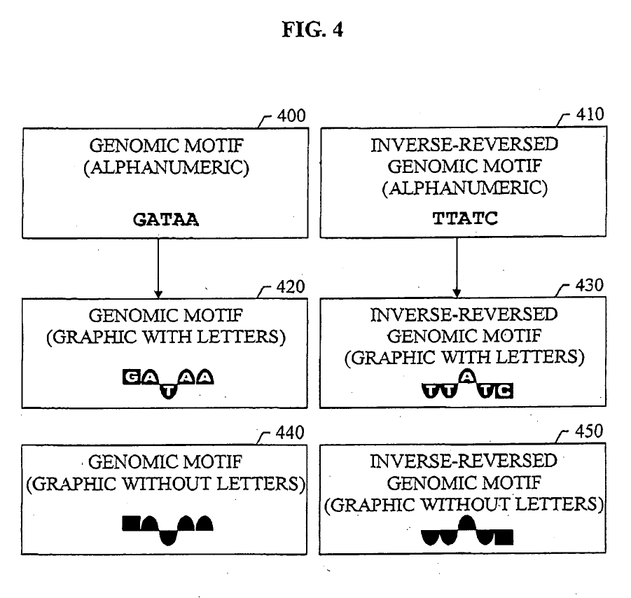

Reference is now made to FIG. 4 which is a simplified illustration of an example demonstrating an advantage of the graphic genomic representation 130 of FIG. 1, in comparing a genomic motif sequence with the inverse-reverse thereof.

Genomic motifs are short genomic sequences, which may have a specific biological significance or action. Genomic motifs may be compared to ‘words’, insofar as a word is a combination of English letters and has a specific meaning, and a genomic motif is a combination of a genomic nucleotides, and may have a specific action. An example for a well known genomic motif is the genomic sequence ‘GATAA’.

As is well known in the art, genomic sequence data is typically provided for a sequence of nucleotides on a positive strand of the DNA. However, some segments of biologically significant genomic data are actually ‘coded’ on the negative, i.e. opposite, strand of the DNA. In order to determine the ‘real’ sequence data for such segments it is necessary to inverse-reverse the sequence received from the positive strand, as is well known in the art. To inverse-reverse means to read the sequence from right to left, and replace each A with a T, and each C with a G and vice-versa. For example, ‘TTATC’ is the inverse-reverse of the genomic motif ‘GATAA’. The action of inverse-reversing genomic sequences is very frequently used, especially when analyzing genomic motifs. For example, the genomic motif ‘GATAA’ may appear in the genomic sequence either as ‘GATAA’, or as its inverse-reverse ‘TTATC’. However, using the standard alphanumeric presentation, it may not be easy to visually determine the similarity between such a motif and its inverse-reverse.

As noted above with reference to FIG. 1, the genomic graphic representation 130 of FIG. 1, provides the user with enhanced ease of visually discerning genomic motifs from their inversed-reversed sequences, inasmuch as the inversed-reversed sequence presents a horizontal and vertical mirror image of the original motif. This is due to the fact that complementary nucleotide pairs adenine-thymine and cytosine-guanine, are graphically represented by complementary vertical halves of the same shape, as described with reference to FIG. 1.

FIG. 4 enables comparison between the genomic sequence ‘GATAA’ which is a well known genomic motif, and the genomic sequence ‘TTATC’ which is the inverse-reverse of this genomic motif. It is seen that the graphical representation of the inversed-reversed genomic motif ‘TTATC’ as designated by reference numeral 440, presents a vertical and horizontal mirror image of the genomic motif ‘GATAA’ as designate by reference numeral 450. This provides the user with enhanced ease of visually discerning the similarity of these motifs. The same is true for the graphic representation with embedded letters, as depicted by reference numerals 420 and 430 respectively.

Reference is now made to FIG. 5, which is a simplified illustration of an example demonstrating an advantage of graphic genomic representation 130 of FIG. 1, in visually distinguishing adenine-thymine-rich sequences, from cytosine-guanine-rich sequences.

An example is given of a genomic sequence “CCCGCTCCAGG”, which is a GC-rich sequence, and a genomic sequence “TTTATTATCTA”, which is an AT-rich sequence. Reference numerals 500 and 510 respectively designate these sequences in standard alphanumeric form, whereas reference numerals 520 & 530 and 540 & 550 respectively designate these sequences graphically, with embedded letters and without embedded letters respectively.

It is appreciated that the genomic graphic representation 130 of FIG. 1 provides the user with enhanced ease of visually discerning GC-rich sequences, depicted by reference numerals 520 and 540, in which the predominant shapes are squares, from AT-rich sequences, depicted by reference numerals 530 and 550, in which the predominant shapes are ovals. This may be particularly useful, since AT-rich sequences and GC-rich sequences may have different genomic significance, as is well known in the art.

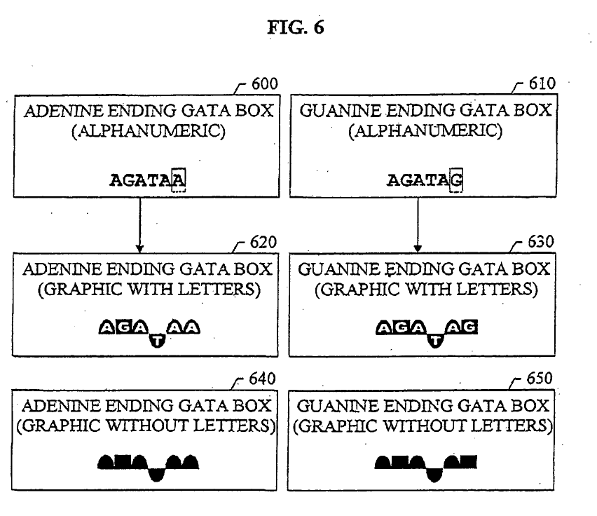

Reference is now made to FIG. 6 which is a simplified illustration of an example which demonstrates an advantage of graphic genomic representation 130 of FIG. 1, in visually distinguishing purine nucleotides from pyrimidine nucleotides.

As is well known in the art, meaningful genomic motifs often appear in a genome with slight variations, while still maintaining their biological function and significance. A motif in which variations are known to happen, is typically described in terms of a ‘consensus-sequence’ which is a description of the location and frequency of acceptable ‘mistakes’, notwithstanding which the biological function of the motif is maintained. A consensus-sequence may be compared to an English word, for which several slightly different spellings may be considered acceptable, e.g. Haematology and Hematology.

Often, the consensus sequence may be related to a biochemical type of nucleotides. For example, the consensus-sequence definition for the well known genomic motif ‘GATA box’ is WGATAR, where W stands for adenine or thymine nucleotide, and R stands for a purine nucleotides: either adenine or guanine. The consensus-sequence in this example, states that both ‘AGATAÄ’ and ‘AGATA\ddot{G}’ may have the same biological function, despite the difference in the last nucleotide, since both adenine and guanine are purine nucleotides.

The present invention provides the user with enhanced ease of visually discerning purine nucleotides from pyrimidine nucleotides, thereby making it easier to visually identify genomic consensus-sequence motifs in which the consensus-sequence definition contains a purine or a pyrimidine.

FIG. 6 provides an example of the two genomic sequences ‘AGATAÄ’ and ‘AGATA\ddot{G}’ mentioned above, both being variants of the same consensus-sequence motif WGATAR mentioned above.

Reference numeral 600 designates a genomic alphanumeric representation of an adenine ending GATA box, ‘AGATAÄ’, and reference numeral 610 designates a genomic graphic representation of a guanine ending GATA box, ‘AGATA\ddot{G}’For clarity, the purine nucleotide ending the GATA box, adenine in reference numeral 600 and guanine in reference numeral 610, is surrounded by a broken-line border.

Reference numerals 640 and 650 designate genomic graphic representations of these two variants of the WGATAR motif: ‘AGATAÄ’, and ‘AGATA\ddot{G}’ respectively.

It is appreciated that the genomic graphic representation 130 of FIG. 1 makes it easier to visually identify the similarity between these two variants of the same ‘GATA box’ consensus sequence, since adenine and guanine, which are both purine nucleotides, are graphically represented by upward oriented shapes: upward oriented half-oval 151 and upward oriented half-square 153 respectively. The same is clearly true of the graphic representation with embedded letters, as depicted by reference numerals 620 and 630 respectively.

It is appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specifications and which are not in the prior art.

What is claimed is:

1. A method for displaying genomic sequence data, the method including:
receiving an alphanumeric string representing genomic sequence data, said alphanumeric sting comprising a plurality of characters, each of said characters representing a nucleotide in said genomic sequence; and
expressing said alphanumeric string using a representation which distinguishes a first plurality of nucleotides, sharing in common a first genomic attribute, from a second plurality of nucleotides, sharing in common a second genomic attribute, said second genomic attribute being different from said first genomic attribute.

2. A method according to claim 1 and wherein said first plurality of nucleotides are represented by at least one first representing attribute, and said second plurality of nucleotides are represented by at least one second representing attribute, said second representing attribute being different from said first representing attribute.

3. A method according to claim 1 and wherein said representation comprises a human sensible representation.

4. A method according to claim 2 and wherein said representation comprises a human sensible representation.

5. A method according to claim 4 and wherein said at least one first representing attribute and said at least one second representing attribute are graphical attributes.

6. A method according to claim 5 and wherein said graphical attributes are shapes.

7. A method according to claim 5 and wherein said graphical attributes are positions.

8. A method according to claim 7 and wherein said positions are vertical positions.

9. A method according to claim 5 and wherein said graphical attributes are orientations.

10. A method according to claim 9 and wherein said orientations are vertical orientations.

11. A method according to claim 5 and wherein said graphical attributes are colors.

12. A method according to claim 4 and wherein using said representation also includes representing each of the following four nucleotides:
adenine,
thymine,
cytosine, and
guanine,
by a different color.

13. A method according to claim 5 and wherein said human sensible representation comprises one of the following: a shape with a letter and a shape without a letter.

14. A method according to claim 5 and wherein said human sensible representation is produced using a computer font.

15. A method according to claim 14 and wherein said computer font is a TRUETYPE® font.

16. A method according to claim 1 and wherein said representation comprises a machine sensible representation.

17. A method according to claim 2 and wherein said representation comprises a machine sensible representation.

18. A method according to claim 17 and wherein said at least one first representing attribute and said at least one second representing attribute are machine sensible attributes.

19. A method according to claim 2 and wherein said first plurality of nucleotides are purine nucleotides, and said second plurality of nucleotides are pyrimidine nucleotides.

20. A method according to claim 2 and wherein said first plurality of nucleotides consists of adenine and thymine nucleotides, and said second plurality of nucleotides consists of guanine and cytosine nucleotides.

21. A method according to claim 2 and wherein said representation also distinguishes a third plurality of nucleotides, sharing in common a third genomic attribute, from a fourth plurality of nucleotides, sharing in common a fourth genomic attribute, said fourth genomic attribute being different from said third genomic attribute.

22. A method according to claim 21 and wherein said third plurality of nucleotides are represented by at least one third representing attribute, and said fourth plurality of nucleotides are represented by at least one fourth representing attribute, said at least one third representing attribute being different from said at least one fourth representing attribute.

23. A method according to claim 21 and wherein said first plurality of nucleotides are purine nucleotides, said second plurality of nucleotides are pyrimidine nucleotides, said third plurality of nucleotides are adenine and thymine nucleotides, and said fourth plurality of nucleotides are guanine and cytosine nucleotides.

24. A method of graphically displaying genomic sequence information, said method comprising:
receiving a first alphanumeric string representing a first genomic sequence and a second alphanumeric string representing a second genomic sequence, said second genomic sequence being a reversed-inversed genomic sequence of said first genomic sequence; and
graphically displaying said first alphanumeric string and said second alphanumeric string, such that a graphical display of said second alphanumeric string is a horizontal and vertical mirror image of a graphical display of said first alphanumeric string.

25. A method according to claim 24 and wherein said method also comprises expressing said first alphanumeric string and said second alphanumeric string using a representation which distinguishes a first plurality of nucleotides, sharing in common a first genomic attribute, from a second plurality of nucleotides, sharing in common a second genomic attribute, said second genomic attribute being different from said first genomic attribute.

26. A method according to claim 25 and wherein said first plurality of nucleotides are represented by at least one first representing attribute, and said second plurality of nucleotides are represented by at least one second representing attribute, said second representing attribute being different from said first representing attribute.

27. A method according to claim 25 and wherein said representation comprises a human sensible representation.

28. A method according to claim 26 and wherein said representation comprises a human sensible representation.

29. A method according to claim 28 and wherein said at least one first representing attribute and said at least one second representing attribute are graphical attributes.

30. A method according to claim 29 and wherein said graphical attributes are shapes.

31. A method according to claim 29 and wherein said graphical attributes are positions.

32. A method according to claim 31 and wherein said positions are vertical positions.

33. A method according to claim 29 and wherein said graphical attributes are orientations.

34. A method according to claim 33 and wherein said orientations are vertical orientations.

35. A method according to claim 29 and wherein said graphical attributes are colors.

36. A method according to claim 28 and wherein using said representation also includes representing each of the following four nucleotides:
adenine,
thymine,
cytosine, and
guanine,
by a different color.

37. A method according to claim 29 and wherein said human sensible representation comprises one of the following: a shape with a letter and a shape without a letter.

38. A method according to claim 29 and wherein said human sensible representation is produced using a computer font.

39. A method according to claim 38 and wherein said computer font is a FRUETYPE® font.

40. A method according to claim 26 and wherein said first plurality of nucleotides are purine nucleotides, and said second plurality of nucleotides are pyrimidine nucleotides.

41. A method according to claim 26 and wherein said first plurality of nucleotides consists of adenine and thymine nucleotides, and said second plurality of nucleotides consists of guanine and cytosine nucleotides.

42. A method according to claim 26 and wherein said representation also distinguishes a third plurality of nucleotides, sharing in common a third genomic attribute, from a fourth plurality of nucleotides, sharing in common a fourth genomic attribute, said fourth genomic attribute being different from said third genomic attribute.

43. A method according to claim 42 and wherein said third plurality of nucleotides are represented by at least one third representing attribute, and said fourth plurality of nucleotides are represented by at least one fourth representing attribute, said at least one third representing attribute being different from said at least one fourth representing attribute.

44. A method according to claim 42 and wherein said first plurality of nucleotides are purine nucleotides, said second plurality of nucleotides are pyrimidine nucleotides, said third plurality of nucleotides are adenine and thymine nucleotides, and said fourth plurality of nucleotides are guanine and cytosine nucleotides.

45. A genomic display system comprising:
a genomic sequence expressor operative to receive an alphanumeric string representing genomic sequence data, said alphanumeric string comprising a plurality of characters, each of said plurality of characters representing a nucleotide in said genomic sequence, and to express said alphanumeric string using a representation which distinguishes a first plurality of nucleotides, sharing in common a first genomic attribute, from a second plurality of nucleotides, sharing in common a second genomic attribute, said second genomic attribute being different from said first genomic attribute;
a display operative to receive an output from said expressor and to display said genomic sequence using said representation.

46. A genomic display system according to claim 45 and wherein said genomic sequence expressor is operative to express said alphanumeric string in a manner wherein said first plurality of nucleotides are represented by at least one first representing attribute, and said second plurality of nucleotides are represented by at least one second representing attribute, said second representing attribute being different from said first representing attribute.

47. A genomic display system according to claim 45 and wherein said representation comprises a human sensible representation.

48. A genomic display system according to claim 46 and wherein said representation comprises a human sensible representation.

49. A genomic display system according to claim 48 and wherein said at least one first representing attribute and said at least one second representing attribute are graphical attributes.

50. A genomic display system according to claim 49 and wherein said graphical attributes are shapes.

51. A genomic display system according to claim 49 and wherein said graphical attributes are positions.

52. A genomic display system according to claim 51 and wherein said positions are vertical positions.

53. A genomic display system according to claim 49 and wherein said graphical attributes are orientations.

54. A genomic display system according to claim 53 and wherein said orientations are vertical orientations.

55. A genomic display system according to claim 49 and wherein said graphical attributes are colors.

56. A genomic display system according to claim 48 and wherein using said representation includes representations of each of the following four nucleotides:
adenine,
thymine,
cytosine, and
guanine,
in a different color.

57. A genomic display system according to claim 49 and wherein said human sensible representation comprises one of the following: a shape with a letter and a shape without a letter.

58. A genomic display system according to claim 49 and wherein said human sensible representation employs a computer font.

59. A genomic display system according to claim 58 and wherein said computer font is a TRUETYPE® font.

60. A genomic display system according to claim 45 and wherein said representation comprises a machine sensible representation.

61. A genomic display system according to claim 46 and wherein said representation comprises a machine sensible representation.

62. A genomic display system according to claim 61 and wherein said at least one first representing attribute and said at least one second representing attribute are machine sensible attributes.

63. A genomic display system according to claim 46 and wherein said first plurality of nucleotides are purine nucleotides, and said second plurality of nucleotides are pyrimidine nucleotides.

64. A genomic display system according to claim 46 and wherein said first plurality of nucleotides consists of adenine and thymine nucleotides, and said second plurality of nucleotides consists of guanine and cytosine nucleotides.

65. A genomic display system according to claim 46 and wherein said genomic sequence expressor is also operative to express said alphanumeric string in a manner wherein a third plurality of nucleotides are represented by at least one third representing attribute, and a fourth plurality of nucleotides are represented by at least one fourth representing attribute, said fourth representing attribute being different from said third representing attribute.

66. A genomic display system according to claim 65 and wherein said third plurality of nucleotides are represented by at least one third representing attribute, and said fourth plurality of nucleotides are represented by at least one fourth representing attribute, said at least one third representing attribute being different from said at least one fourth representing attribute.

67. A genomic display system according to claim 65 and wherein said first plurality of nucleotides are purine nucleotides, said second plurality of nucleotides are pyrimidine nucleotides, said third plurality of nucleotides are adenine and thymine nucleotides, and said fourth plurality of nucleotides are guanine and cytosine nucleotides.

68. A system for graphically displaying genomic sequence information, the system comprising:
a genomic sequence expressor, receiving a first alphanumeric string representing a first genomic sequence and a second alphanumeric string representing a second genomic sequence, said second genomic sequence being a reversed-inversed genomic sequence of said first genomic sequence; and expressing said first alphanumeric string and said second alphanumeric string, in a manner wherein that a graphical expression of said second alphanumeric string is a horizontal and vertical mirror image of a graphical expression of said first alphanumeric string; and
a display operative to receive an output from said genomic sequence expressor and to provide a visually sensible display of said graphical expression of said first alphanumeric string and said graphical expression of said second alphanumeric string.

69. A genomic display system according to claim 68 and wherein:
said genomic sequence expressor is also operative to receive an alphanumeric string which represents genomic sequence data, said alphanumeric string comprising a plurality of characters, each of said plurality of characters representing a nucleotide in said genomic sequence, and to express said alphanumeric string using a representation which distinguishes a first plurality of nucleotides, sharing in common a first genomic attribute, from a second plurality of nucleotides, sharing in common a second genomic attribute, said second genomic attribute being different from said first genomic attribute; and
said display is also operative to receive an output from said expressor and to display said genomic sequence using said representation.

70. A genomic display system according to claim 69 and wherein said genomic sequence expressor is operative to express said alphanumeric string in a manner wherein said first plurality of nucleotides are represented by at least one first representing attribute, and said second plurality of nucleotides are represented by at least one second representing attribute, said second representing attribute being different from said first representing attribute.

71. A genomic display system according to claim 69 and wherein said representation comprises a human sensible representation.

72. A genomic display system according to claim 70 and wherein said representation comprises a human sensible representation.

73. A genomic display system according to claim 72 and wherein said at least one first representing attribute and said at least one second representing attribute are graphical attributes.

74. A genomic display system according to claim 73 and wherein said graphical attributes are shapes.

75. A genomic display system according to claim 73 and wherein said graphical attributes are positions.

76. A genomic display system according to claim 75 and wherein said positions are vertical positions.

77. A genomic display system according to claim 73 and wherein said graphical attributes are orientations.

78. A genomic display system according to claim 77 and wherein said orientations are vertical orientations.

79. A genomic display system according to claim 73 and wherein said graphical attributes are colors.

80. A genomic display system according to claim 72 and wherein using said representation also includes representing each of the following four nucleotides:
adenine,
thymine,
cytosine, and
guanine,
by a different color.

81. A genomic display system according to claim 73 and wherein said human sensible representation comprises one of the following: a shape with a letter and a shape without a letter.

82. A genomic display system according to claim 73 and wherein said human sensible representation is produced using a computer font.

83. A genomic display system according to claim 82 and wherein said computer font is a TRUETYPE® font.

84. A genomic display system according to claim 70 and wherein said first plurality of nucleotides are purine nucleotides, and said second plurality of nucleotides are pyrimidine nucleotides.

85. A genomic display system according to claim 70 and wherein said first plurality of nucleotides consists of adenine and thymine nucleotides, and said second plurality of nucleotides consists of guanine and cytosine nucleotides.

86. A genomic display system according to claim 70 and wherein said representation also distinguishes a third plurality of nucleotides, sharing in common a third genomic attribute, from a fourth plurality of nucleotides, sharing in common a fourth genomic attribute, said fourth genomic attribute being different from said third genomic attribute.

87. A genomic display system according to claim 86 and wherein said third plurality of nucleotides are represented by at least one third representing attribute, and said fourth plurality of nucleotides are represented by at least one fourth representing attribute, said at least one third representing attribute being different from said at least one fourth representing attribute.

88. A genomic display system according to claim 86 and wherein said first plurality of nucleotides are purine nucleotides, said second plurality of nucleotides are pyrimidine nucleotides, said third plurality of nucleotides are adenine and thymine nucleotides, and said fourth plurality of nucleotides are guanine and cytosine nucleotides.

89. A computer-readable medium comprising a computer program, the computer program being operative, when in operative association with a computer, to perform the following steps:
receiving an alphanumeric string representing genomic sequence data, said alphanumeric string comprising a plurality of characters, each of said characters representing a nucleotide in said genomic sequence; and
expressing said alphanumeric string using a representation which distinguishes a first plurality of nucleotides, sharing in common a first genomic attribute, from a second plurality of nucleotides, sharing in common a second genomic attribute, said second genomic attribute being different from said first genomic attribute.

90. A computer-readable medium according to claim 89 and wherein said first plurality of nucleotides are represented by at least one first representing attribute, and said second plurality of nucleotides are represented by at least one second representing attribute, said second representing attribute being different from said first representing attribute.

91. A computer-readable medium according to claim 89 and wherein said representation comprises a human sensible representation.

92. A computer-readable medium according to claim 90 and wherein said representation comprises a human sensible representation.

93. A computer-readable medium according to claim 92 and wherein said at least one first representing attribute and said at least one second representing attribute are graphical attributes.

94. A computer-readable medium according to claim 93 and wherein said graphical attributes are shapes.

95. A computer-readable medium according to claim 93 and wherein said graphical attributes are positions.

96. A computer-readable medium according to claim 95 and wherein said positions are vertical positions.

97. A computer-readable medium according to claim 93 and wherein said graphical attributes are orientations.

98. A computer-readable medium according to claim 97 and wherein said orientations are vertical orientations.

99. A computer-readable medium according to claim 93 and wherein said graphical attributes are colors.

100. A computer-readable medium according to claim 92 and wherein using said representation also includes representing each of the following four nucleotides:
adenine,
thymine,
cytosine, and
guanine,
by a different color.

101. A computer-readable medium according to claim 93 and wherein said human sensible representation comprises one of the following: a shape with a letter and a shape without a letter.

102. A computer-readable medium according to claim 93 and wherein said human sensible representation is produced using a computer font.

103. A computer-readable medium according to claim 102 and wherein said computer font is a TRUETYPE® font.

104. A computer-readable medium according to claim 89 and wherein said representation comprises a machine sensible representation.

105. A computer-readable medium according to claim 90 and wherein said representation comprises a machine sensible representation.

106. A computer-readable medium according to claim 105 and wherein said at least one first representing attribute and said at least one second representing attribute are machine sensible attributes.

107. A computer-readable medium according to claim 90 and wherein said first plurality of nucleotides are purine nucleotides, and said second plurality of nucleotides are pyrimidine nucleotides.

108. A computer-readable medium according to claim 90 and wherein said first plurality of nucleotides consists of adenine and thymine nucleotides, and said second plurality of nucleotides consists of guanine and cytosine nucleotides.

109. A computer-readable medium according to claim 90 and wherein said representation also distinguishes a third plurality of nucleotides, sharing in common a third genomic attribute, from a fourth plurality of nucleotides, sharing in common a fourth genomic attribute, said fourth genomic attribute being different from said third genomic attribute.

110. A computer-readable medium according to claim 109 and wherein said third plurality of nucleotides are represented by at least one third representing attribute, and said fourth plurality of nucleotides are represented by at least one fourth representing attribute, said at least one third representing attribute being different from said at least one fourth representing attribute.

111. A computer-readable medium according to claim 109 and wherein said first plurality of nucleotides are purine nucleotides, said second plurality of nucleotides are pyrimidine nucleotides, said third plurality of nucleotides are adenine and thymine nucleotides, and said fourth plurality of nucleotides are guanine and cytosine nucleotides.

112. A computer-readable medium comprising a computer program, the computer program being operative, when in operative association with a computer, to perform the following steps:
receiving a first alphanumeric string representing a first genomic sequence and a second alphanumeric string representing a second genomic sequence, said second genomic sequence being a reversed-inversed genomic sequence of said first genomic sequence; and
graphically displaying said first alphanumeric string and said second alphanumeric string, such that a graphical display of said second alphanumeric string is a horizontal and vertical mirror image of a graphical display of said first alphanumeric string.

113. A method according to claim 112 and wherein said method also comprises expressing said first alphanumeric string and said second alphanumeric string using a representation which distinguishes a first plurality of nucleotides, sharing in common a first genomic attribute, from a second plurality of nucleotides, sharing in common a second genomic attribute, said second genomic attribute being different from said first genomic attribute.

114. A method according to claim 113 and wherein said first plurality of nucleotides are represented by at least one first representing attribute, and said second plurality of nucleotides are represented by at least one second representing attribute, said second representing attribute being different from said first representing attribute.

115. A method according to claim 113 and wherein said representation comprises a human sensible representation.

116. A method according to claim 114 and wherein said representation comprises a human sensible representation.

117. A method according to claim 116 and wherein said at least one first representing attribute and said at least one second representing attribute are graphical attributes.

118. A method according to claim 117 and wherein said graphical attributes are shapes.

119. A method according to claim 117 and wherein said graphical attributes are positions.

120. A method according to claim 119 and wherein said positions are vertical positions.

121. A method according to claim 117 and wherein said graphical attributes are orientations.

122. A method according to claim 121 and wherein said orientations are vertical orientations.

123. A method according to claim 117 and wherein said graphical attributes are colors.

124. A method according to claim 116 and wherein using said representation also includes representing each of the following four nucleotides:
adenine,
thymine,
cytosine, and
guanine,
by a different color.

125. A method according to claim 117 and wherein said human sensible representation comprises one of the following: a shape with a letter and a shape without a letter.

126. A method according to claim 117 and wherein said human sensible representation is produced using a computer font.

127. A method according to claim 126 and wherein said computer font is a TRUETYPE® font.

128. A method according to claim 114 and wherein said first plurality of nucleotides are purine nucleotides, and said second plurality of nucleotides are pyrimidine nucleotides.

129. A method according to claim 114 and wherein said first plurality of nucleotides consists of adenine and thymine nucleotides, and said second plurality of nucleotides consists of guanine and cytosine nucleotides.

130. A method according to claim 114 and wherein said representation also distinguishes a third plurality of nucleotides, sharing in common a third genomic attribute, from a fourth plurality of nucleotides, sharing in common a fourth genomic attribute, said fourth genomic attribute being different from said third genomic attribute.

131. A method according to claim 130 and wherein said third plurality of nucleotides are represented by at least one third representing attribute, and said fourth plurality of nucleotides are represented by at least one fourth representing attribute, said at least one third representing attribute being different from said at least one fourth representing attribute.

132. A method according to claim 130 and wherein said first plurality of nucleotides are purine nucleotides, said second plurality of nucleotides are pyrimidine nucleotides, said third plurality of nucleotides are adenine and thymine nucleotides, and said fourth plurality of nucleotides are guanine and cytosine nucleotides.


SEQUENCE LISTING (1 sequence)

SEQ ID NO: 1 - DNA, 30 bp, Artificial
  Hypothetical sequence for respresentative purposes
actttgataattattgtaactgtaaaagat